(19) United States
(12) Patent Application Publication
(10) Pub. No.: US 2003/0040944 A1
(43) Pub. Date: Feb. 27, 2003

(54) On-demand transportation system

(76) Inventor: Ryan M. Hileman, Seattle, WA (US)

Correspondence Address: BLACK LOWE & GRAHAM, 816 SECOND AVE., SEATTLE, WA, 98104, US

(21) Appl. No.: 09/935,564

(22) Filed: Aug. 22, 2001

(51) Int. Cl. G06F 17/60

(52) U.S. Cl. 705/5

(57) ABSTRACT

The transportation system and method includes a server in communication with a user and a vehicle via a wired or wireless data channel. The user provides the server with transportation request information, and requests transportation options from the server. The user may seek transportation either for a passenger or for a package or other item to be transported for delivery to a specified destination. The server evaluates the transportation request information provided by the user and determines transportation options, including available routes of travel (times, paths, etc.) and the charges associated with the various available routes of travel. The server notifies the user of transportation options, including available routes of travel and associated charges. The user selects one of the transportation options and requests transportation according to the specified travel parameters. The server books the requested transportation and notifies the transporting vehicle of the new transportation assignment.

### FIELD OF THE INVENTION

This invention relates generally to transportation systems and, more specifically, to an on-demand transportation system and method used to coordinate passenger and package transportation and calculate the charges for such services.

### BACKGROUND OF THE INVENTION

Public transportation has long been available to route passengers to various destinations. There are significant advantages to public transportation over private transportation. Public transportation involving one or a few passengers, such as via taxi or shuttle, allows convenient pick up from and delivery to varied locations. Use of such public transportation eliminates the need to purchase, maintain and operate personal vehicles, thereby simplifying and reducing travel expenses for many individuals. Mass public transportation operates on a larger scale. Mass public transportation, such as via larger shuttles or buses, typically incorporates vehicles that allow transport of large numbers of passengers to their various destinations. Mass public transportation is made possible by fixing pick up and delivery locations and by scheduling travel based on standard routes of travel.

One of the significant challenges to public transportation services involves calculating a passenger's fare. If the fare is calculated by distance traveled, it may not account for the time spent reaching the passenger pick up location, or the extra time spent carrying the passenger due to traffic conditions or other factors. A taximeter calculates the fare based on a combination of distance traveled and time stopped (or below a certain speed). Such a system does not account for time spent traveling slowly versus traveling along an uncrowded freeway. Moreover, such systems do not allow passengers to know in advance the amount of the fare, creating discomfort for passengers who prefer to know the amount of the fare in advance.

Mass public transportation and some taxi systems use a zone system to calculate set fares in advance of travel. Passengers pay according to the zone or zones in which they travel, as well as the time of day or week during which they travel. Zone systems do not typically account for traveling time, the time spent reaching the passenger pick up location, or the extra time spent carrying the passenger due to traffic conditions or other factors.

Thus, there is a need for a system and method for evaluating transportation needs and calculating transportation charges that overcomes the noted disadvantages and provides an efficient and effective transportation system.

### SUMMARY OF THE INVENTION

The present invention provides an on-demand transportation system and method for scheduling passenger and package transportation. The system includes a user system for use by a user to schedule passenger or package transportation, the user system having a communications device capable of wired or wireless communication; a vehicle having a vehicle user for providing passenger or package transportation, the vehicle including a wireless communications device for transmitting and receiving wireless information, a user interface for allowing the vehicle user to perform various interactive functions, and a processing system having a processor, a memory, and a database for controlling vehicle system components; a server maintaining information on logistical and geographic features of the area for which transportation of passengers or packages is offered, information on the location, capacity, and availability of the vehicle to transport passengers or packages, and information on current, historical and anticipated traffic conditions along possible routes of travel for which transportation of passengers or packages, is offered; and a data channel providing wired or wireless communication among the user system, vehicle, and server.

The method includes receiving transportation request information from the user system for passenger or package transportation via the data channel, determining optimal routes of travel for passenger or package transportation, calculating charges associated with optimal routes for passenger or package transportation, and notifying the user system of transportation options via the data channel. The transportation request information from the user system for passenger or package transportation may include origination, destination, travel time, and the number of passengers or type of packages to be transported.

The step of determining optimal routes of travel for passenger or package transportation may include determining possible routes of travel based on the transportation request information, determining vehicles capable of providing the requested passenger or package transportation along possible routes of travel, determining vehicle transportation information for vehicles capable of providing the requested passenger or package transportation along possible routes of travel, vehicle transportation information including vehicle location, capacity and availability information, and determining predicted traffic conditions along possible routes of travel based on existing and historical traffic conditions. These same factors may be considered in calculating charges associated with the passenger or package transportation.

If the user selects one of the transportation options, the method includes ordering transportation according to the selected transportation option, scheduling transportation for the passenger or package according to the selected transportation option, and updating the server with information on the selected transportation option.

The step of calculating charges associated with optimal routes for passenger or package transportation may include requesting account authorization for payment of the requested transportation if account information exists on the server associated with the passenger or package. If no account information exists on the server associated with the passenger or package, the server establishes an account associated with the passenger or package. Once a recognizable account is established, the server requests account authorization for the requested transportation. If account authorization for the requested transportation is obtained, the server charges the account associated with the passenger or package for the requested transportation. If at any point account authorization for the requested transportation is not obtained, the server notifies the user system of alternative payment options.

As will be readily appreciated from the foregoing summary, the invention provides a system and method for evaluating transportation needs and calculating transportation charges that accounts for traveling time, traffic conditions, and other factors affecting the efficiency of the transportation process.

### BRIEF DESCRIPTION OF THE DRAWINGS

The preferred and alternative embodiments of the present invention are described in detail below with reference to the following drawings.

FIG. 1 is a diagram illustrating an exemplary system for performing functions of the present invention;

FIG. 2 is a flow chart illustrating an overview operation of the present invention;

FIG. 3 is a flow chart illustrating operation of the scheduling and charge determination aspects of the present invention;

FIG. 4 is a flow chart illustrating operation of the account authorization aspect of the present invention;

FIG. 5 is a flow chart illustrating operation of an order delivery aspect of the present invention;

FIG. 6 is a flow chart illustrating operation of a service request aspect of the present invention;

FIG. 7 is a flow chart illustrating operation of package delivery aspect of the present invention; and

FIG. 8 is a flow chart illustrating operation of a passenger delivery aspect of the present invention.

### DETAILED DESCRIPTION OF THE PREFERRED EMBODIMENT

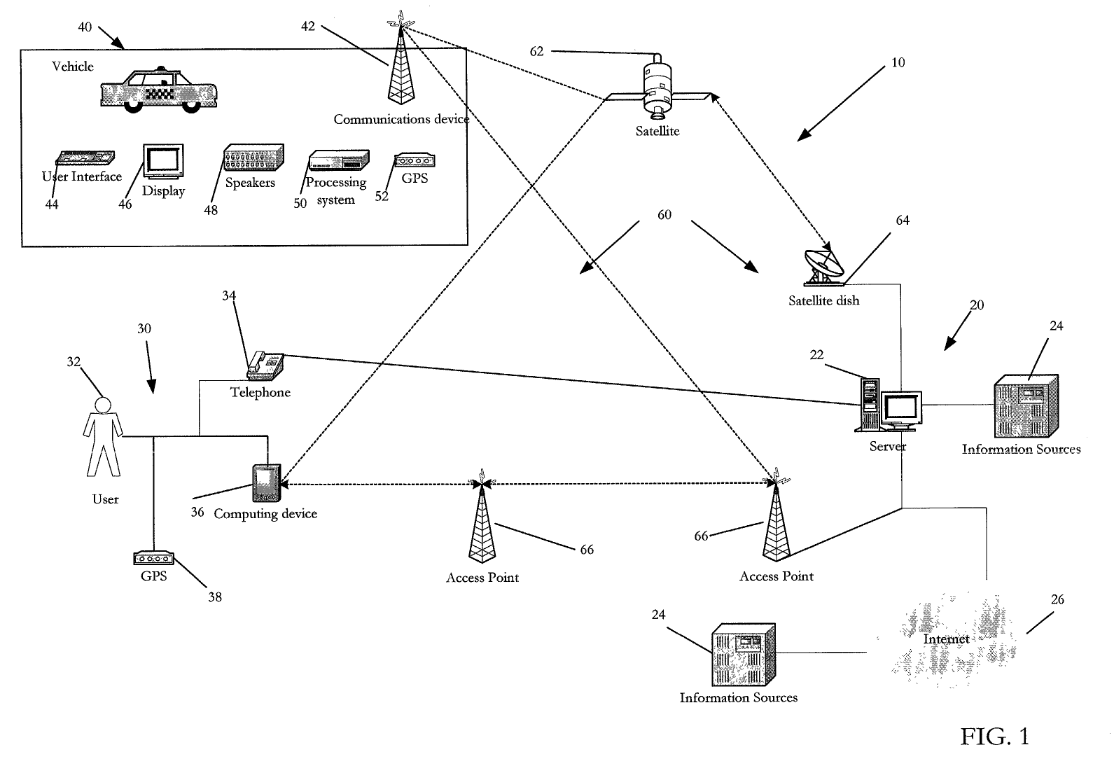

The present invention provides a system and method for evaluating and scheduling transportation needs and calculating associated transportation charges. FIG. 1 shows one embodiment of a transportation system 10 of the present invention. The transportation system includes a server system 20 in communication with a user system 30 and a vehicle 40 via a wired or wireless data channel 60.

More specifically, FIG. 1 illustrates the particular components of the embodiment of transportation system 10. Server system 20 includes a server 22 for housing user system information, as well as processing and responding to requests for information from user system 30 and obtaining and using information from information sources 24, which may be integral with or independent from server system 20. The server maintains information on streets, rails, airports, water ports, and other logistical and geographic features for the area for which transportation is offered. The server also maintains information on the location, capacity, and availability of vehicle 40, including such information as the number of current and predicted passengers or payloads, past routes of vehicle travel, current and future route assignments, vehicle attributes, and capacity based on current and predicted passengers or payloads. The server also maintains information on current, historical and anticipated traffic conditions along possible routes of travel supported by vehicle 40, as well as information on road condition and capacity. Current traffic condition information may include traffic data from Department of Transportation and other flow pattern and volume cameras and sensors; traffic data received real-time from vehicle 40 or other vehicles, whether part of or independent from transportation system 10; accident reports obtained from a number of sources, including law enforcement; and traffic data from other public and private sources. Historical and anticipated traffic condition information may include traffic condition data related to the day of the week, month and season; proximity in time to holidays or scheduled events such as concerts, sports, and road construction work; and information related to users' prior experiences involving the same or analogous transportation. Server 20 may also include the identity and credit authorization information on user 32, as well as technical information on the vehicle, such as make, model and license. The server system may also maintain historical and current location information for the vehicle.

In the preferred embodiment, server 22 includes a processor, a memory, and a database (not shown). Server 22 may be in communication with information sources 24 via direct access (e.g., hard-wired or point-to-point connection) as well as over Internet 26. Server system 20 further includes a means for sending and receiving information to and from vehicle 40, discussed below. In an alternative embodiment, server system 20 may include a human operator that receives and enters information into the server, and otherwise manages some or all of the server system operations.

User system 30 includes user 32, which may be an automated system but in the preferred embodiment is a human operator. The user system further includes a communications device, such as a telephone 34 or a computing device 36 (e.g., PDA), or like device with wired or wireless communication capabilities, for transmitting and receiving information from user 32 to server 22 or other recipient. The communications device includes a communications interface, which may be integral with or a separate but connected part of the communications device. In an alternative embodiment, the user system further includes a global positioning system (GPS) 38 or other means (e.g., caller identification) for determining precise user system location.

Vehicle 40 is preferably one or several vehicles in a fleet, such as a taxi, bus, or package delivery fleet, but may be any type or size of vehicle capable of meeting the transportation requirements of the present system, and may further include, for example, rail transit systems, delivery trucks, air travel systems, etc. In a preferred embodiment, vehicle 40 includes a wireless communications device 42, such as a cellular modem, for transmitting and receiving wireless information; a user interface 44, such as a keyboard or microphone, for allowing the vehicle user to perform various interactive functions; a display 46; speakers 48; a processing system 50, preferably having a processor, a memory, and a database (not shown), for monitoring and controlling vehicle system components, and a GPS 52 for determining precise vehicle location. In an alternative embodiment, GPS 52 may be replaced by a different system, such as a manual system, where the precise vehicle location is determined and communicated in another fashion, such as by a human operator.

Data channel 60 facilitates communication of instructions and information among server 20, user system 30, and vehicle 40. In a preferred embodiment, the data channel may include a satellite system 62 in combination with a satellite dish 64, along with or in the place of one or more access points 66, the latter as part of a cellular or other wireless transmission network. The data channel may also include means for direct access (e.g., hard-wired or point-to-point connection), such as over a telephone line or via the Internet.

In operation, information and instructions are transmitted from user system 30 via communications device 34 or 36, or vehicle 40 via communication device 42, to either the satellite system or access point, which in turn communicate the instructions to server system 20, in the former case via satellite dish 64. In an alternative embodiment, information and instructions may be transmitted directly from user system 30 to the server system, for example via hard-wired or point-to-point communication. Conversely, information and instructions may be communicated from the server to the vehicle along a reverse direction of the same route.

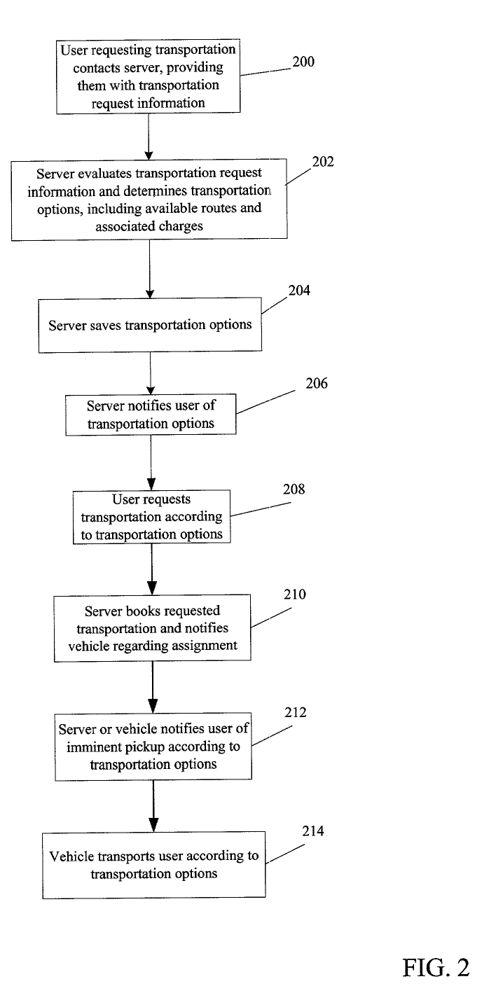

An overview operation of the present invention is understood with reference to FIG. 2. At block 200, user 32, via user system 30, provides server system 20 and, ultimately, server 22, with transportation request information, and requests transportation options from the server system. The user may seek transportation for either a passenger, such as user 32, or for a package or other item to be transported for delivery to a specified destination. At block 202, the server evaluates the transportation request information provided by the user and determines transportation options, including available routes of travel (times, paths, etc.) and the charges associated with the various available routes of travel. In the preferred embodiment, at block 204, the server saves the transportation options in the server memory or database. Transportation request information, as well as determined transportation options, may be saved at a single or several points during the described operation. At block 206, the server notifies the user of transportation options, which includes travel parameters such as available routes of travel and associated charges. At block 208, if desired, the user selects one of the transportation options, and requests transportation according to the specified travel parameters. At block 210, the server books the requested transportation and notifies the transporting vehicle of the new transportation assignment. At block 212, the server or vehicle notifies the user of the imminent pickup of the passenger or package according to the transportation options. At block 214, the passenger or package is picked up and transported to the specified destination according to the transportation options.

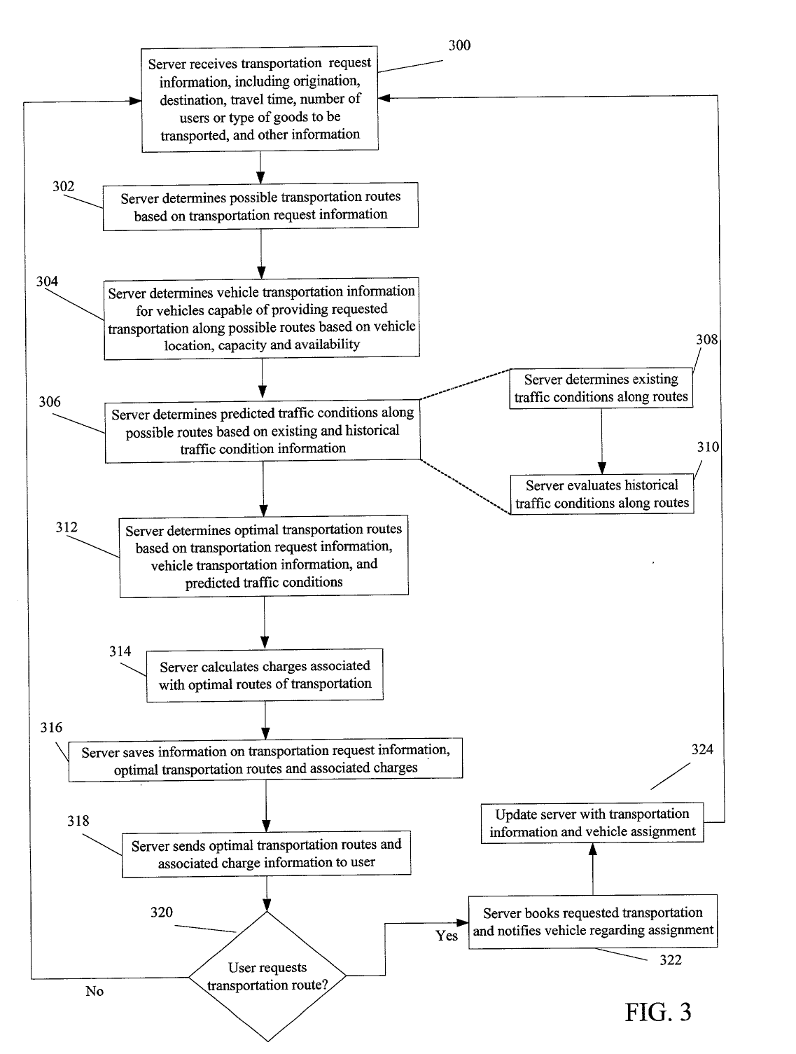

The specific operational aspects of the present invention are better understood with reference to the various alternative embodiments shown in FIGS. 3-8. FIG. 3 is a flow chart illustrating operation of the scheduling and charge determination aspects of the present invention. While the system is equally applicable in the situation of a passenger or a package delivery, it will be described principally with reference to the passenger situation only. At block 300, the server receives transportation request information from a user. The transportation request information preferably includes the passenger origination and destination (specific address or known transit or transfer center), the preferred travel times (month, week, day, hour or specific time of day), and the number of passengers or type and number of goods to be transported. The transportation request information may also include other information, such as specifics as to the mode of transportation desired, the preferred route taken, and an acceptable cost range.

At block 302, the server determines the possible transportation routes based on the transportation request information. The possible transportation routes between the requested origination and destination are a function of the practical routes available between the two locations based on street, rail, airport, water port, and other logistical and geographic information maintained in the server database and the vehicles in the system capable of providing the requested transportation. Once the server has identified the possible transportation routes and the vehicles capable of providing transportation along the routes, at block 304, the server determines vehicle transportation information for the vehicles capable of providing the requested transportation. This is a function of current vehicle location, capacity, and availability information, all of which is maintained in the server memory or database and updated as necessary to ensure real-time information is available to the server to evaluate new transportation requests. Preferably, vehicle location and capacity information is updated automatically based upon sensory devices located in each vehicle, such as a GPS or other location device to determine present vehicle location and sensors to determine open seats or storage spaces. Vehicle availability information is preferably updated automatically by the vehicle processor or the server, or both, as passengers or packages are added or removed. Vehicle availability information relates to the existing scheduled pickups and deliveries, including such information as the number of current and predicted passengers or payloads, past routes of vehicle travel, current and future route assignments and capacity based on current and predicted passengers or payloads. Vehicle transportation information (location, capacity, and availability) may also be updated by alternative means, for example by verbal communication from the vehicle user to the server system for subsequent entry into the server memory or database.

At block 306, the server determines the predicted traffic conditions along the possible routes of travel. This is a function of current and historical traffic conditions along possible transportation routes supported by transportation vehicles. The server system obtains current traffic condition information (block 308) from information sources 24, which may include traffic data from Department of Transportation flow pattern and volume cameras and sensors; traffic data received real-time from vehicle 40 or other vehicles, whether part of or independent from transportation system 10; accident reports obtained from a number of sources, including law enforcement; and traffic data from other public and private sources. Historical traffic condition information (block 310), maintained in the server memory or database, may include traffic condition data related to the day of the week, month and season; proximity in time to holidays or scheduled events such as concerts, sports, and road construction work; and information related to the requesting passenger or sender's prior experiences involving the same or analogous transportation.

At block 312, the server determines the optimal transportation routes based on the transportation request information, the vehicle transportation information, and the predicted traffic conditions. This may be a prioritized list of all possible routes and modes of travel, or a partial list showing only a predetermined number or type of routes and modes. At block 314, the server calculates the charges associated with the optimal transportation routes. The charge determined for each route is a function of the extent to which the resource, in this case the vehicle, is to be used by the passenger or sender. Stated differently, the charge is based on the lost opportunity cost of providing the requested transportation. The charge is calculated based first on how much time the passenger or package delivery will utilize the vehicle, and second how much time the vehicle will be “taken away” from other passengers using the service or package deliveries. For example, if a passenger is traveling to or from a place that is distant from all other current passengers, there may be a greater charge than a passenger traveling to or from a place in common to a majority of other passengers. In this example, the latter situation ties up less resources than the former, and thus there would be a lower associated charge. Various factors are evaluated in calculating the charges associated with optimal transportation routes. These factors may include the distance to be traveled between origination and destination; the proximity of the passenger or package pickup or delivery to the intended vehicle transportation route; the type of vehicle or mode of transportation involved; the condition of the transportation route (i.e., road condition); the weather conditions along the route; the predicted traffic conditions along the route; the current and anticipated schedule and transportation route of the vehicle; and priority of the existing and requesting passengers and packages.

One of the advantages of the present invention is that it addresses the problem of efficiently reaching the last mile of passenger drop-off or delivery, getting the passenger or package to a location in close proximity to the destination for a predetermined or flat-fee charge. By using the outlined factors to determine identical and overlapping transportation requirements, the present invention provides financially feasible point-to-point or near point-to-point transportation service. By using the outlined factors to assess proper resource value and calculate a highly accurate charge for transportation, the present invention provides a charge calculation that closely approximates the actual cost of providing the transportation resource. In addition, the present invention addresses the granularity problem historically associated with public or pooled transportation, namely, the effect of incremental changes in travel schedule and traffic on changes to the amount of fare that a passenger must pay. Stated differently, existing public transportation models deal with the perception that there must be a substantial change between different trips to justify changes in fare required for each trip; i.e., one must travel a substantially greater distance to justify a larger fare, or the amount of traffic encountered must be substantial such as during rush hour to require a greater fare. The present invention evaluates many variables—allowing it to provide the advantages noted above, including a simple, fixed charge—without a surprising, after-the-fact, and often substantial change in the charge.

At block 316, the server saves transportation request information and information on the determined optimal transportation routes and associated charges in the server memory or database. Saving this information provides a backup record of the pending user transaction in the event that communication with the user is terminated. Saving this information also allows for subsequent integration into historical database records for use to track consumer demand. As noted above, transportation request information and information on the determined optimal transportation routes and associated charges may be saved at any time, or multiple times, during the described system operation.

At block 318, the server sends optimal transportation routes and associated charge information to the user. In an alternative embodiment, the server may send information in addition to only the optimal transportation routes, such as a prioritized list of all possible routes and modes of travel, or a partial list showing only a predetermined number or type of routes and modes. At decision block 320, a determination is made whether the user selected any of the proposed transportation routes. If the user declines to select a proposed transportation route, the logic of the system returns to block 300 to await a subsequent transportation request from the same or a different user. If the user selects a proposed transportation route, the logic proceeds to block 322. At block 322, the server obtains user identification information, books the requested transportation, and notifies the transporting vehicle of the new transportation assignment. User identification information may also be obtained at a different stage in the described operational logic, for example, at the time the user initially makes a transportation request (block 300). At block 324, the server updates server memory or database with transportation information and the vehicle assignment, thereby updating the status of the vehicle for future transportation scheduling as well as enhancing the database with information to use in subsequent transportation option determinations, for example, providing specific user transfer parameters that may be referenced in future transportation requests to expedite the process. In an alternative embodiment, the vehicle updates the server with information on the completion of the transportation, including the specifics of the transportation time, the weather conditions, traffic conditions, etc. This information is added to the server database for use in subsequent transportation option determinations. The logic of the system returns to block 300 to await a subsequent transportation request from the same or a different user. Not shown or described in this example, but equally applicable to this embodiment, is the notification aspect of the invention described with reference to block 212 of FIG. 2, and the accompanying specification.

In an alternative embodiment, the server may book or reserve one or more optimal transportation routes (and save associated charge information) for the user at block 318, or prior to receiving the user request at block 320. In some instances the timeliness of reserving resources (vehicles) makes it important to act quickly, and the server, perhaps based on historical reservation fulfillment information for the particular user, may preemptively make the reservation. In addition, making the reservation at this stage may protect against accidental disconnect from the vehicle. If the user subsequently declines the travel option, the server immediately frees up the resource.

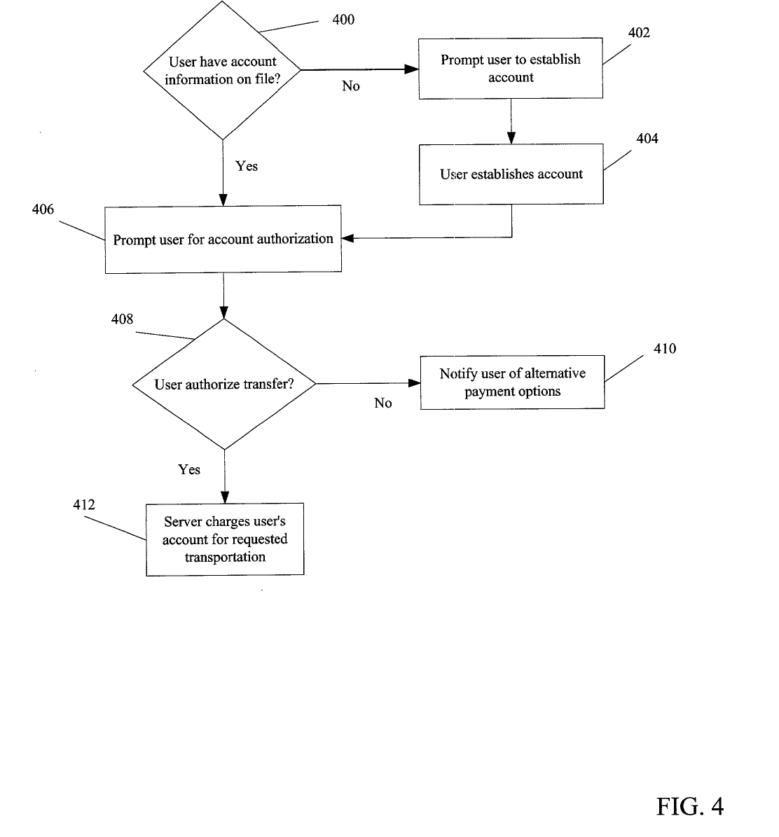

Payment for transportation services may be accomplished in person or real-time at the passenger or package pickup or drop-off location. In an alternative embodiment, payment may occur electronically at any number of stages during the operational procedure described above, for example at the time that the server books the requested transportation. This electronic payment system can be used with any of the various embodiments of the present invention. With further reference to FIG. 4, an electronic payment embodiment that may be incorporated into the operational logic of the present invention. At decision block 400, the server determines, based on user identification information, whether the user has account information on file in the server memory or database. If the user does not have account information on file, at block 402, the user is prompted to establish an account. At block 404, the user establishes an account recognizable by transportation system 10, and the logic continues to block 406. If, at decision block 400, the server determines that the user has account information on file, the logic proceeds to block 406.

At block 406, the server prompts the user for authorization to charge the noted account for the cost of the requested transportation. This may be accomplished in a number or ways, such as verbally over telephone 34, or through electronic authorization via a computing device 36. If, at decision block 408, the user does not authorize the electronic transfer of the necessary funds, the logic proceeds to block 410, where the server notifies the user of alternative payment options, such as are described above. If, at decision block 408, the user authorizes transfer of the necessary funds, the logic proceeds to block 412, where the server charges the user's account for payment for the requested transportation. Preferably, this is accomplished by charging a credit card number associated with the user.

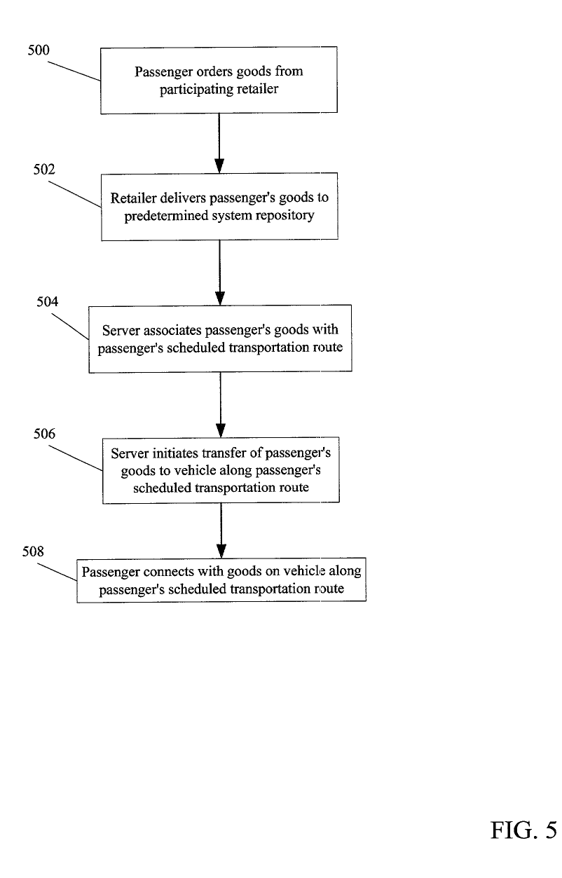

FIG. 5 is a flow chart illustrating operation of an order delivery aspect of the present invention. In this embodiment, a passenger uses transportation system 10 to facilitate the timely and convenient delivery of goods ordered from a participating retailer. At block 500, a user intending to be a passenger in transportation system 10 remotely orders goods from a participating retailer, for example over the telephone or via the Internet. The order preferably includes information such as the passenger's identification and anticipated transportation schedule using transportation system 10. At block 502, the participating retailer delivers the passenger's goods to a predetermined system repository or vehicle transit or transfer location. The goods are accompanied, at a minimum, by passenger identification information and unique goods identification information. The goods may also be accompanied by the passenger's anticipated transportation schedule. This information is forwarded to server system 20. In a preferred embodiment, information associated with the goods, for example passenger identification information and goods identification information, are scanned into processing system 50 of vehicle 40 or at a system repository, and the information is transmitted via data channel 60 to the server for integration with server memory and database records.

At block 504, the server associates the passenger's goods with the passenger's transportation schedule. In other words, the server determines the most efficient manner and schedule to transport the passenger's goods to a vehicle to be ridden by the passenger in sufficient time that the passenger can link up with the goods enroute to the passenger's destination. This presupposes that the user is a passenger who has already made a request for travel on the system, or concurrently places a request for future travel. The association between the passenger's goods and the passenger's transportation schedule is preferably accomplished by accessing the receiving vehicle's intended route schedule and the passenger's transportation schedule from the server memory or database, and determining the route that the goods must travel, including transfer to other vehicles and system repositories, to reach the passenger's vehicle in time to connect with the passenger while the passenger is traveling on a vehicle to the passenger's destination. In a preferred embodiment, the passenger is notified that the package will be delivered to the vehicle.

At block 506, the server initiates the transfer of the passenger's goods to the passenger's scheduled transportation vehicle. Preferably the passenger identification information and goods identification information, along with the passenger transportation schedule, is maintained in association with the goods throughout the process, and scanned in at each vehicle or repository for transfer and update of the information at the server. At block 508, the passenger connects with the goods on the scheduled transportation vehicle along the passenger's scheduled transportation route and, preferably, confirms receipt of the goods, which confirmation may be reported back to server system 20.

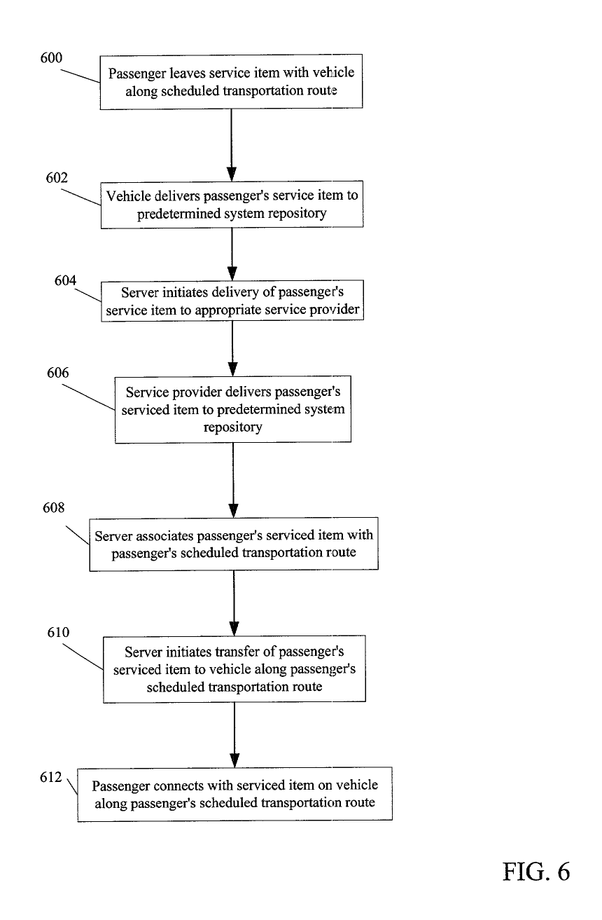

FIG. 6 is a flow chart illustrating operation of a service request aspect of the present invention. In this embodiment, an owner or user of a item to be serviced uses transportation system 10 to facilitate the timely and convenient delivery and pickup of a service item from a service provider. At block 600, a user leaves the service item, for example a clothing item to be dry-cleaned, with a vehicle at a vehicle transit or transfer location or at a system repository. In an alternative embodiment the service item receives curbside pickup. The user may have previously made arrangements with the service provider for which the service item is intended, or alternatively may use a service provider participating with transportation system 10, for which service provisioning has been prearranged. The service item is accompanied by user identification information and unique service item identification information. The service item may also be accompanied by the user's anticipated transportation schedule, should the user desire to coordinate delivery of the serviced items to user transportation in transportation system 10. This information is forwarded to server system 20. In a preferred embodiment, information associated with the service item, for example user identification information and service item identification information, are scanned into processing system 50 of vehicle 40 or at a system repository, and the information is transmitted via data channel 60 to the server, for integration with server memory and database records. At block 602, the receiving vehicle delivers the service item to a vehicle at a vehicle transit or transfer location or a predetermined system repository.

At block 604, the server initiates delivery of the user's service item to the specified service provider for service. After performing the requested service, at block 606, the service provider delivers the serviced item to a vehicle at a vehicle transit or transfer location or a predetermined system repository. The serviced item is accompanied by user identification information and unique service item identification information. The serviced item may also be accompanied by the user's anticipated transportation schedule, should the user intend to be a passenger and to coordinate delivery with travel in transportation system 10. This information is forwarded to server system 20, again preferably by scanning pertinent information and electronic transfer.

At block 608, the server associates the user's serviced item with the user's desired pickup location or, if the user is to be a passenger on transportation system 10, with the user's transportation schedule, as outlined above. Once the necessary transfer route is determined, at block 610, the server initiates the delivery of the serviced item to the delivery location, or transfer of the user's serviced item to the user's scheduled transportation vehicle. Preferably the user identification information and good identification information is maintained in association with the service item throughout the process, and scanned in at each vehicle or repository for transfer and update of the information at the server. At block 612, the user connects with the serviced item at the delivery location, on the scheduled transportation vehicle along the user's scheduled transportation route, or at another specified delivery location. In a preferred embodiment, the recipient confirms receipt of the item.

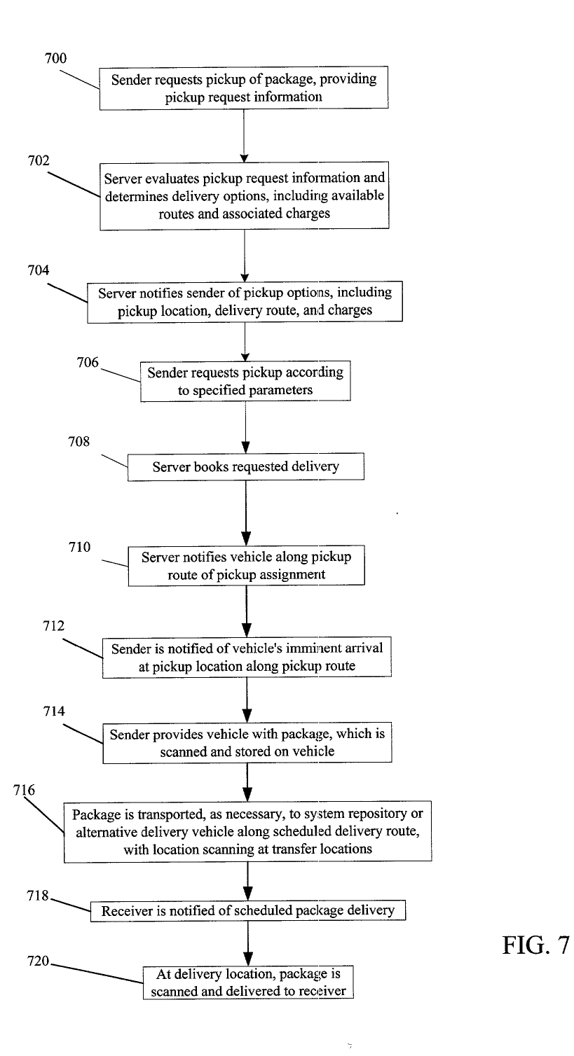

FIG. 7 is a flow chart illustrating operation of a package delivery aspect of the present invention. In this embodiment, a sender or receiver other than a passenger can use transportation system 10 to facilitate the timely and convenient pickup and delivery of packages anywhere within the system's service area. At block 700, a sender requests pickup of a package by providing pickup request information to server 22 via user system 30 across data channel 60. Pickup request information includes, for example, package origination, destination, priority, and physical size and weight information. In an alternative embodiment, another agent may initiate the pickup request, even the recipient. At this or a later stage in the logic of the operation the sender provides the server with sender identification information. At block 702, the server evaluates the pickup request information and determines delivery options, including available routes and charges. This process is described in more detail with reference to blocks 302-314 of FIG. 3, and the accompanying specification. At block 704, the server notifies the sender of the delivery options, including the pickup locations, delivery routes and charges. At block 706, the sender selects a delivery option, and requests pickup according to specified parameters. At block 708, using sender identification information, the server books the requested delivery and updates server memory or database with delivery information and the vehicle assignment, thereby updating the status of the vehicle for future transportation scheduling, as well as enhancing the database with information for use in subsequent transportation option determinations, for example, providing specific user transfer parameters that may be referenced in future transportation requests to expedite the process. At block 710, the server notifies the transporting vehicle of the new transportation assignment.

Once the vehicle assigned for pickup approaches the pickup location, at block 712, the server directly or through the vehicle notifies the sender of the vehicle's imminent arrival at the pickup location. This can be accomplished in a variety of ways, including by direct verbal contact, or by automated notification verbally or via remote electronic notification, for example via computing device 36. At block 714, the sender provides the pickup vehicle with the package, preferably including sender identification information, package identification information, destination information and recipient information. In a preferred embodiment, this information is scanned and transferred to the server. At block 716, the package is transported, as necessary, to the system repository or alternative delivery vehicle located along the scheduled delivery route. The package information is preferably scanned at each transfer location and the information is sent to the server to maintain and update records on the status of the delivery.

As the delivery vehicle approaches the delivery destination, at block 718, the receiver is notified of the scheduled package delivery. As described above, this can be accomplished verbally or automatically by electronic means. The receiver is informed of the delivery location and time so as to meet and obtain the package In an alternative embodiment, transportation system 10 allows the receiver input as to the delivery location. For example, the receiver, upon being notified of the scheduled package delivery, may alter the scheduled delivery location or time, or in an alternative embodiment even the delivery recipient. At block 720, at the delivery location, the package is delivered to the receiver, preferably after appropriate receipt authorization is received and the package has been scanned at the destination location. The server may subsequently be updated with this delivery information.

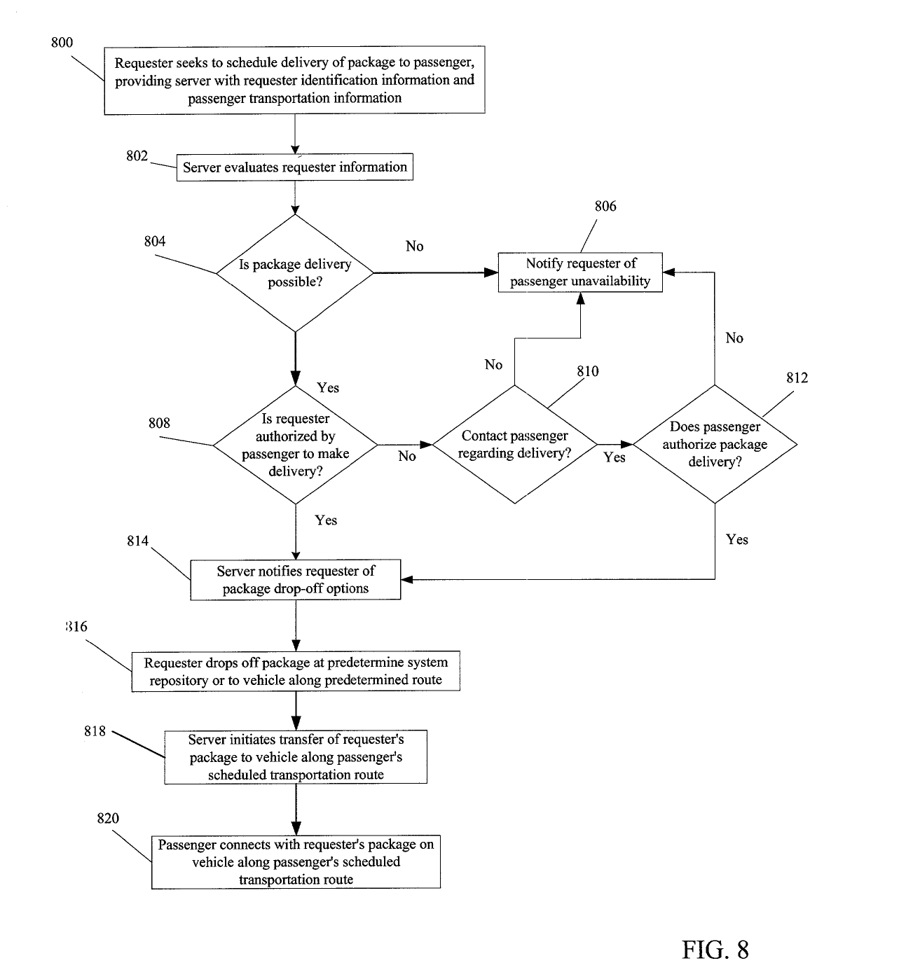

FIG. 8 is a flow chart illustrating operation of a passenger delivery aspect of the present invention. In this embodiment, a requestor seeks to schedule delivery of a package or other item or information to a passenger of transportation system 10. At block 800, a requester seeks to schedule the delivery of a package to a passenger. The requester provides the server with requester identification information, passenger identification information, and, if known, passenger schedule information. At block 802, the server evaluates the requester and passenger identification information by recalling and reviewing requester and passenger identification information and passenger transportation route information, if available. See generally the discussion above with reference to blocks 302-314 of FIG. 3. At decision block 804, a determination is made whether, based on the requester's proposed delivery schedule and the passenger's scheduled travel route, the requested package delivery is possible. If not, the logic proceeds to block 806, where the server notifies the requester of passenger unavailability. If the requested package delivery is possible, the logic proceeds to decision block 808, where a determination is made whether the requester is authorized by the passenger to make a package delivery. Previous passenger authorization may already be stored in the system for specific or ongoing deliveries from the requestor. If not, the logic proceeds to decision block 810, where the server, via known contact information or, if the passenger is currently traveling on the transportation system, via the passenger vehicle, attempts to contact the passenger. If the passenger cannot be contacted, the logic proceeds to block 806, where the server notifies the requester of passenger unavailability. If the server is able to make contact with the passenger, the logic proceeds to decision block 812, where a determination is made whether the passenger authorizes package delivery. If the passenger does not authorize package delivery, the logic proceeds to block 806, where the server notifies the requester of passenger unavailability. If the passenger authorizes package delivery, either at block 812 or directly based on previous authorization maintained by the server at decision block 808, the logic proceeds to block 814.

At block 814, the server notifies the requester that package delivery has been authorized, and provides the requester with package drop-off options. In an alternative embodiment, at this or other stage in the described process, the server may request payment. See generally steps 400-412 of FIG. 4, and accompanying specification. At block 816, the requester provides the package at the predetermined system repository or to a vehicle along a predetermined route, preferably including requestor identification information, package identification information, and passenger information. In a preferred embodiment, this information is scanned and transferred to the server. At block 818, the server initiates the transfer of the requester's package to the passenger's scheduled transportation vehicle. Preferably the passenger identification information and package identification information, along with the passenger transportation schedule, is maintained in association with the package throughout the process, and scanned in at each vehicle or repository for transfer and update of the information at the server. At block 820, the passenger connects with the package on the scheduled transportation vehicle along the passenger's scheduled transportation route.

While the preferred embodiment of the invention has been illustrated and described, as noted above, many changes can be made without departing from the spirit and scope of the invention. As described above, the specific order in which the steps of the invention may be performed may vary substantially without sacrificing the functionality of the invention. For example, the specific time at which transportation request or option information is saved to the server, transportation reservations are made by the server, or users are charged or pay for system services, may vary. In addition, while notification of imminent passenger or package pickup is only described in certain situations, such notification may occur regardless of the particular embodiment. Likewise, the payment requests steps 400-412 described with reference to FIG. 4, or equivalents thereof, may be used with or applied to any of the embodiments as a means of obtaining payment from users of the present system. In addition, while specific factors used to evaluate transportation options and calculate transportation charges are described, such factors are for exemplary purposes only; other factors may be included in making such evaluations and calculations. Also, it is anticipated that one or more of the alternative embodiments described be combined, in sum or total, to provide mixed transportation services, such as transporting both a package and a passenger, originating in different locations, to a common location. The disclosed and claimed transportation system is equally applicable to meet passenger, package, or passenger and package transportation needs. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An on-demand transportation system for use in scheduling at least one of passenger or package transportation, comprising:
a user system for scheduling the at least one of passenger or package transportation, the user system having a communications device capable of communication;
a vehicle having a vehicle user for providing the at least one of passenger or package transportation, the vehicle comprising a communications device for transmitting and receiving information, a user interface for allowing the vehicle user to perform various interactive functions, and a processing system having a processor, a memory, and a database for controlling vehicle system components;
a server maintaining information on logistical and geographic features of the area for which transportation of the at least one of passenger or package is offered, information on the location, capacity, and availability of the vehicle to transport the at least one of passenger or package, and information on current and historical traffic conditions along possible routes of travel for which transportation of the at least one of passenger or package is offered; and
a data channel providing communication among the user system, vehicle, and server.

2. The on-demand transportation system of claim 1, wherein the server further maintains identity and credit authorization information associated with the at least one of passenger or package.

3. The on-demand transportation system of claim 1, wherein the server comprises a memory, the memory containing stored program instructions executable by the server, comprising:
a component configured to receive transportation request information via the data channel for the at least one of passenger or package transportation;
a component configured to evaluate the transportation request information to determine transportation options, including available routes of travel and costs associated with transporting the at least one of passenger or package;
a component configured to notify the user system of transportation options via the data channel; and
a component configured to schedule transportation for the at least one of passenger or package according to a transportation option selected.

4. The on-demand transportation system of claim 3, wherein the component configured to evaluate the transportation request information to determine transportation options, including available routes of travel and costs associated with transporting the at least one of passenger or package, utilizes information on the logistical and geographic features of the area for which transportation of the at least one of passenger or package is offered, the location, capacity, and availability of the vehicle to transport the at least one of passenger or package, and current and historical traffic conditions along possible routes of travel for which transportation of the at least one of passenger or package is offered.

5. The on-demand transportation system of claim 3, wherein the component configured to schedule transportation for the at least one of passenger or package according to the selected transportation option comprises:
if account information exists in the server associated with the at least one of passenger or package, requesting account authorization for payment for the requested transportation;
if account information does not exist in the server associated with the at least one of passenger or package,
establishing an account associated with the at least one of passenger or package; and
requesting account authorization for payment for the requested transportation;
if account authorization for the requested transportation is obtained, charging the account associated with the at least one of passenger or package for the requested transportation; and
if account authorization for the requested transportation is not obtained, providing notification of alternative payment options.

6. The on-demand transportation system of claim 1, wherein the data channel further comprises a satellite system having a satellite dish facilitating information exchange among the user system, vehicle, and server.

7. An on-demand transportation system for use in scheduling at least one of passenger or package transportation, comprising:
a means for scheduling the at least one of passenger or package transportation, the means having a communications device capable of communication;
a transportation means for providing the at least one of passenger or package transportation, the means comprising a communications device for transmitting and receiving information, and a processing system having a processor, a memory, and a database for controlling vehicle system components;
a means for maintaining information on at least one of logistical and geographic features of the area for which transportation of the at least one of passenger or package is offered, information on the location, capacity, and availability of transportation means to transport the at least one of passenger or package, and information on current and historical traffic conditions along possible routes of travel for which transportation of the at least one of passenger or package is offered; and
a means for providing communication among the user system, vehicle, and server.

8. The on-demand transportation system of claim 7, wherein the means for scheduling the at least one of passenger or package transportation is configured to evaluate the transportation request information to determine transportation options, including available routes of travel and costs associated with transporting the at least one of passenger or package, utilizes information on the logistical and geographic features of the area for which transportation of the at least one of passenger or package is offered, the location, capacity, and availability of the vehicle to transport the at least one of passenger or package, and current and historical traffic conditions along possible routes of travel for which transportation of the at least one of passenger or package is offered.

9. A method for scheduling at least one of passenger or package transportation in an on-demand transportation system, the on-demand transportation system having a user system for scheduling the at least one of passenger or package transportation capable of communication, a vehicle having a vehicle user for providing the at least one of passenger or package transportation and capable of transmitting and receiving information, a server maintaining information relevant to the at least one of passenger or package transportation, and a data channel providing communication among the user system, vehicle, and server, the method comprising:
requesting transportation information from the server for the at least one of passenger or package transportation via the data channel, the request including transportation request information;
evaluating the transportation request information to determine transportation options, including available routes of travel and costs associated with transporting the at least one of passenger or package;
notifying the user system of transportation options via the data channel;
selecting transportation according to at least one of the transportation options; and
scheduling transportation for the at least one of passenger or package according to the at least one of the selected transportation options.

10. The method for scheduling the at least one of passenger or package transportation in an on-demand transportation system of claim 9, wherein the server comprises a server memory, and the method further comprises saving the transportation options in the server memory.

11. The method for scheduling the at least one of passenger or package transportation in an on-demand transportation system of claim 9, further comprising determining charges associated with the at least one of passenger or package transportation in the on-demand transportation system.

12. The method for scheduling the at least one of passenger or package transportation in an on-demand transportation system of claim 11, wherein determining charges associated with the at least one of passenger or package transportation in the on-demand transportation system is dependent on at least one of logistical and geographic features of the area for which delivery is offered, the location, capacity, and availability of at least one delivery vehicle, and current and historical traffic conditions along possible delivery routes.

13. A method for scheduling at least one of passenger or package transportation in an on-demand transportation system, the on-demand transportation system having a user system for scheduling the at least one of passenger or package transportation capable of communication, a vehicle for providing the at least one of passenger or package transportation and capable of transmitting and receiving information, a server maintaining information relevant to the at least one of passenger or package transportation, and a data channel providing communication among the user system, vehicle, and server, comprising:
receiving transportation request information from the user system for the at least one of passenger or package transportation via the data channel;
determining routes of transportation for the at least one of passenger or package transportation;
calculating charges associated with routes for the at least one of passenger or package transportation;
notifying the user system of transportation options via the data channel;
if user system selects a transportation option, selecting transportation according to the selected transportation option;
scheduling transportation for the at least one of passenger or package according to the selected transportation option; and
updating the server with information on the selected transportation option.

14. The method for scheduling the at least one of passenger or package transportation in an on-demand transportation system of claim 13, wherein the server comprises a server memory, and the method further comprises saving the transportation options in the server memory.

15. The method for scheduling the at least one of passenger or package transportation in an on-demand transportation system of claim 13, wherein transportation request information from the user system for the at least one of passenger or package transportation includes one or more of origination, destination, travel time, and at least one of number of passengers or type of packages to be transported.

16. The method for scheduling the at least one of passenger or package transportation in an on-demand transportation system of claim 13, wherein determining optimal routes of transportation for the at least one of passenger or package transportation comprises:
determining possible routes of travel based on the transportation request information;
determining vehicles capable of providing the at least one of requested passenger or package transportation along possible routes of travel;
determining vehicle transportation information for vehicles capable of providing the at least one of requested passenger or package transportation along possible routes of travel, vehicle transportation information including vehicle location, capacity and availability information; and
determining predicted traffic conditions along possible routes of travel based on existing and historical traffic conditions.

17. The method for scheduling the at least one of passenger or package transportation in an on-demand transportation system of claim 13, wherein scheduling transportation for the at least one of passenger or package according to the selected transportation option comprises:
if account information exists in the server associated with the at least one of passenger or package, requesting account authorization for the requested transportation;
if account information does not exist in the server associated with the at least one of passenger or package,
establishing an account associated with the at least one of passenger or package; and
requesting account authorization for the requested transportation;
if account authorization for the requested transportation is obtained, charging the account associated with the at least one of passenger or package for the requested transportation; and
if account authorization for the requested transportation is not obtained, notifying the user system of alternative payment options.

18. The method for scheduling the at least one of passenger or package transportation in an on-demand transportation system of claim 13, further comprising notifying the user system of the imminent pickup of the at least one of passenger or package according to the selected transportation option.

19. The method for scheduling the at least one of passenger or package transportation in an on-demand transportation system of claim 13, wherein charges associated with routes for the at least one of passenger or package transportation are dependent on at least one of logistical and geographic features of the area for which delivery is offered, the location, capacity, and availability of at least one delivery vehicle, and current and historical traffic conditions along possible delivery routes.

20. A method for scheduling delivery of goods to a passenger in an on-demand transportation system, the on-demand transportation system having at least one vehicle for providing passenger and goods transportation along a travel route and a server maintaining information relevant to passenger and goods transportation, the method comprising:
ordering goods for the passenger from a participating retailer;
submitting passenger goods to the on-demand transportation system;
determining the passenger's scheduled transportation route in the on-demand transportation system;
associating passenger goods with the passenger's scheduled transportation route in the on-demand transportation system; and
transferring passenger goods to a vehicle in the on-demand transportation system that is scheduled to transport the passenger along the passenger's scheduled transportation route.

21. The method for scheduling delivery of goods to a passenger in an on-demand transportation system of claim 20,
wherein the vehicle has vehicle status information; and
the method further comprises:
scanning the package for package status information along the delivery route; and
updating the server with package status information scanned from the package and vehicle status information.

22. The method for scheduling delivery of goods to a passenger in an on-demand transportation system of claim 20, further comprising determining delivery charges associated with delivery of passenger goods to the passenger in the on-demand transportation system.

23. The method for scheduling delivery of goods to a passenger in an on-demand transportation system of claim 22, wherein determining delivery charges associated with delivery of passenger goods to the passenger in the on-demand transportation system is dependent on logistical and geographic features of the area for which delivery is offered, the location, capacity, and availability of at least one delivery vehicle, and current and historical traffic conditions along possible delivery routes.

24. The method for scheduling delivery of goods to a passenger in an on-demand transportation system of claim 20, further comprising charging for delivery of passenger goods to the passenger in the on-demand transportation system.

25. The method for scheduling delivery of goods to a passenger in an on-demand transportation system of claim 24, wherein charging for delivery of passenger goods to the passenger in the on-demand transportation system comprises:
if account information exists in the server associated with the delivery of the passenger goods, requesting account authorization for payment for the requested delivery,
if account information does not exist in the server associated with the delivery of the passenger goods,
establishing an account associated with the delivery of the passenger goods; and
requesting account authorization for payment for the requested delivery;
if account authorization for the requested transportation is obtained, charging the account associated with delivery of the passenger goods for the requested delivery; and
if account authorization for the requested transportation is not obtained, providing notification of alternative payment options.

26. A method for scheduling service for a service item to be delivered to a passenger in an on-demand transportation system, the on-demand transportation system having at least one vehicle for providing passenger and service item transportation along a travel route and a server maintaining information relevant to passenger and service item transportation, the method comprising:
submitting a service item needing service from a service provider to the on-demand transportation system;
transferring the service item to the service provider;
receiving the serviced item from the service provider at the on-demand transportation system;
determining the passenger's scheduled transportation route in the on-demand transportation system;
associating serviced item with the passenger's scheduled transportation route in the on-demand transportation system; and
transferring passenger goods to a vehicle in the on-demand transportation system that is scheduled to transport the passenger along the passenger's scheduled transportation route.

27. The method for scheduling service for a service item to be delivered to a passenger in an on-demand transportation system of claim 26,
wherein the vehicle has vehicle status information; and
the method further comprises:
scanning the package for package status information along the delivery route; and
updating the server with package status information scanned from the package and vehicle status information.

28. The method for scheduling service for a service item to be delivered to a passenger in an on-demand transportation system of claim 26, further comprising determining delivery charges associated with delivery of the service item to the passenger in the on-demand transportation system.

29. The method for scheduling service for a service item to be delivered to a passenger in an on-demand transportation system of claim 28, wherein determining delivery charges associated with delivery of the service item to the passenger in the on-demand transportation system is dependent on logistical and geographic features of the area for which delivery is offered, the location, capacity, and availability of at least one delivery vehicle, and current and historical traffic conditions along possible delivery routes.

30. The method for scheduling service for a service item to be delivered to a passenger in an on-demand transportation system of claim 26, further comprising charging for delivery of the service item to the passenger in the on-demand transportation system.

31. The method for scheduling service for a service item to be delivered to a passenger in an on-demand transportation system of claim 30, wherein charging for delivery of the service item to the passenger in the on-demand transportation system comprises:
if account information exists in the server associated with the delivery of the service item, requesting account authorization for payment for the requested delivery;
if account information does not exist in the server associated with the delivery of the service item,
establishing an account associated with the delivery of the service item; and
requesting account authorization for payment for the requested delivery;
if account authorization for the requested transportation is obtained, charging the account associated with delivery of the service item for the requested delivery; and
if account authorization for the requested transportation is not obtained, providing notification of alternative payment options.

32. A method for sending and receiving a package delivery in an on-demand transportation system, the on-demand transportation system having at least one user system capable of communication for use by at least one of a sender and a receiver in scheduling package pickup and delivery, at least one vehicle capable of transmitting and receiving information for providing package transportation along a travel route, a server maintaining information relevant to package delivery, and a data channel providing communication among the user system, vehicle, and server, the method comprising:
submitting package delivery request information from the sender to the server;
evaluating the delivery request information to determine delivery options, including available pickup routes and delivery routes, and pickup location and delivery location;
notifying the sender of delivery options via the data channel and user system;
selecting delivery according to at least one of the delivery options;
scheduling delivery of the package according to the at least one of the selected delivery options;
notifying the sender via the data channel and a user system of the imminent arrival of a vehicle in the on-demand transportation system at the pickup location along a pickup route;
receiving the package from the sender at the vehicle in the on-demand transportation system at the pickup location along the pickup route;
transferring the package to a vehicle in the on-demand transportation system that is scheduled to transport the package along the delivery route;
notifying the receiver via the data channel and a user system of the scheduled delivery of the package by a vehicle in the on-demand transportation system at the delivery location along the delivery route; and
delivering package to receiver at the delivery location along the delivery route.

33. The method for sending and receiving a package delivery in an on-demand transportation system of claim 32,
wherein the vehicle has vehicle status information; and
the method further comprises:
scanning the package for package status information along the delivery route; and
updating the server with package status information scanned from the package and vehicle status information.

34. The method for sending and receiving a package delivery in an on-demand transportation system of claim 32, wherein determining delivery options further comprises evaluating charges for delivery of the service item to the passenger in the on-demand transportation system.

35. The method for sending and receiving a package delivery in an on-demand transportation system of claim 34, wherein charges for delivery of the service item to the passenger in the on-demand transportation system are dependent on at least one of logistical and geographic features of the area for which delivery is offered, the location, capacity, and availability of at least one delivery vehicle, and current and historical traffic conditions along possible delivery routes.

36. The method for sending and receiving a package delivery in an on-demand transportation system of claim 32, further comprising charging for delivery of the package to the receiver in the on-demand transportation system.

37. The method for sending and receiving a package delivery in an on-demand transportation system of claim 36, wherein charging for delivery of the package to the receiver in the on-demand transportation system comprises:
if account information exists in the server associated with the at least one of sender or receiver, requesting account authorization for payment for the requested delivery;
if account information does not exist in the server associated with the at least one of sender or receiver,
establishing an account associated with the at least one of sender or receiver; and
requesting account authorization for payment for the requested delivery;
if account authorization for the requested transportation is obtained, charging the account associated with the at least one of sender or receiver for the requested delivery; and
if account authorization for the requested transportation is not obtained, providing notification of alternative payment options.

38. A method for scheduling delivery of a package to a passenger in an on-demand transportation system, the on-demand transportation system having at least one user system for use by a delivery requester in scheduling package delivery, at least one vehicle for providing passenger and package transportation along a travel route, a server maintaining information relevant to passenger transportation and package delivery, and a data channel providing communication among the user system, vehicle, and server, comprising:
receiving a package delivery request for delivery of a package to a passenger in the on-demand transportation system from the requester, the request including requester identification information and passenger identification information;
evaluating the package delivery request to determine delivery options, including availability of the passenger in the on-demand transportation system, available pickup routes and passenger route, and pickup location;
if the passenger in the on-demand transportation system is unavailable to receive the delivery, notifying the requester of the passenger unavailability;
determining at the server if the requester has previously been authorized by the passenger to make the delivery;
if the requester is not authorized by the passenger to make the delivery, contacting the passenger regarding authorizing the requester to make the delivery;
if the passenger authorizes delivery of the package, notifying the requester via the data channel and user system of delivery options;
selecting delivery according to at least one of the delivery options;
receiving the package from the requester at a vehicle in the on-demand transportation system at the pickup location along the pickup route;
transferring the package to a vehicle in the on-demand transportation system that is scheduled to transport the package along the passenger route; and
delivering package to passenger along the passenger route.

39. The method for scheduling delivery of a package to a passenger in an on-demand transportation system of claim 38,
wherein the vehicle has vehicle status information; and
the method further comprises:
scanning the package for package status information along the delivery route; and
updating the server with package status information scanned from the package and vehicle status information.

40. The method for scheduling delivery of a package to a passenger in an on-demand transportation system of claim 38, wherein determining delivery options further comprises evaluating charges for delivery of the service item to the passenger in the on-demand transportation system.

41. The method for scheduling delivery of a package to a passenger in an on-demand transportation system of claim 40, wherein charges for delivery of the service item to the passenger in the on-demand transportation system are dependent on at least one of logistical and geographic features of the area for which delivery is offered, the location, capacity, and availability of at least one delivery vehicle, and current and historical traffic conditions along possible delivery routes.

42. The method for scheduling delivery of a package to a passenger in an on-demand transportation system of claim 38, further comprising charging for delivery of the package to the passenger in the on-demand transportation system.

43. The method for scheduling delivery of a package to a passenger in an on-demand transportation system of claim 42, wherein charging for delivery of the package to the passenger in the on-demand transportation system comprises:
if account information exists in the server associated with the package delivery, requesting account authorization for payment for the requested delivery;
if account information does not exist in the server associated with the package delivery,
establishing an account associated with the package delivery; and
requesting account authorization for payment for the requested delivery;
if account authorization for the requested transportation is obtained, charging the account associated with the package delivery for the requested delivery; and
if account authorization for the requested transportation is not obtained, providing notification of alternative payment options.

44. A method for calculating charges associated with transportation of at least one of a passenger or package in an on-demand transportation system having a user system for scheduling the at least one of passenger or package transportation, a vehicle having a vehicle user for providing the at least one of passenger or package transportation, and a server maintaining information on logistical and geographic features of the area for which transportation of the at least one of passenger or package is offered, the method comprising:
receiving the scheduled passenger or package transportation request from the user system;
evaluating information maintained by the server on the logistical and geographic features of the area for which transportation of the at least one of passenger or package is offered;
determining the location, capacity, and availability of the vehicle to transport the at least one of passenger or package;
anticipating traffic conditions in the area for which transportation of the at least one of passenger or package is offered based on current and historical traffic conditions maintained by the server; and calculating charges associated with the transportation of at least one of a passenger or package according to at least one of the logistical and geographic features of the area for which transportation is offered, location, capacity, and availability of the vehicle, and anticipated traffic conditions.
